(19) United States
(12) Patent Application Publication
(10) Pub. No.: US 2026/0261064 A1
(43) Pub. Date: Sep. 3, 2026

(54) FEMALE TERMINAL

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Seido NISHIJIMA, Mie (JP); Akio KIMURA, Mie (JP)

(21) Appl. No.: 18/995,834

(22) PCT Filed: Jul. 24, 2023
(86) PCT No.: PCT/JP2023/026924

§ 371 Date: Jan. 17, 2025

(30) Foreign Application Priority Data
Aug. 4, 2022 (JP) 2022-124615

(51) Int. Cl. H01R 13/187

(52) U.S. Cl. CPC H01R 13/187

(57) ABSTRACT

A female terminal includes a body portion including a box-shaped conductive portion and a pair of contact point forming fittings having a smaller plate thickness than the body portion. The box-shaped conductive portion includes a rear opening window. The pair of contact point forming fittings include a first spring piece and a second spring piece. The first spring piece includes a first contact point. The second spring piece includes a second contact point. A contact pressure applying spring is provided which is arranged on projecting end parts of the respective first and second spring pieces and insertable through the rear opening window. The projecting end parts are biased in directions toward each other to press the first and second contact points into contact with a male terminal as the male terminal is press-fit.

### TECHNICAL FIELD

The present disclosure relates to a female terminal.

### BACKGROUND

A female terminal formed by press-working a metal flat plate is proposed in Patent Document 1. A wire connecting portion formed by overlapping a pair of flat plate portions is provided on a base end side of the female terminal, and a male terminal mounting tube portion, into which a flat tab-shaped male terminal is inserted, is provided on a tip side of the female terminal. The male terminal mounting tube portion includes a pair of L-shaped supporting plate portions projecting toward the tip side after projecting in a direction opposite to an overlapping direction from the respective flat plate portions. The male terminal also includes a pair of contact point spring portions projecting toward the base end side by being cantilevered and coupled to projecting end parts of the pair of supporting plate portions via semicircular curved portions. The pair of contact point spring portions are arranged to face each other across a male terminal insertion gap, and a separate contact pressure applying spring is mounted on tip parts of the pair of contact point spring portions. By this contact pressure applying spring, contact pressures are applied to the male terminal from the pair of contact point spring portions and a stable connected state of the male and female terminals can be held.

### PRIOR ART DOCUMENT

### Patent Document

Patent Document 1: JP 2022-083287 A

### SUMMARY OF THE INVENTION

### Problems to be Solved

However, since the female terminal of Patent Document 1 is formed by press-working the metal flat plate, the contact point spring portions need to have a thickness corresponding to a current capacity. Thus, if a large current needs to flow, plate thicknesses of the contact point spring portions are increased. As a result, to ensure the followability of the contact point spring portions to the male terminal, the contact point spring portions have to be elongated and the female terminal tends to be enlarged in size. Further, if the plate thicknesses of the contact point spring portions are increased, reaction forces of the contact point spring portions when being displaced to follow the male terminal also increase. Thus, an influence on the contact pressures applied by the contact pressure applying spring, a possibility of deformation of the supporting plate portions and the like are also considered. In addition, the contact pressure applying spring needs to be mounted on the tip parts of the pair of contact point spring portions from a side surface side of the contact point spring portions and assembly has been difficult.

Accordingly, a female terminal is disclosed which has improved assemblability capable of suppressing the deformation of the female terminal by stably ensuring followability and a contact pressure to a male terminal while suppressing the enlargement of the female terminal even if it is necessary to be compatible with large currents.

### Means to Solve the Problem

The present disclosure is directed to a female terminal with a body portion including a connecting portion to be conductively connected to another member on one end side in a length direction and a hollow box-shaped conductive portion on the other end side in the length direction, and a pair of contact point forming fittings having a smaller plate thickness than the body portion, the pair of contact point forming fittings being conductively fixed and held on a pair of facing inner surfaces of the box-shaped conductive portion, the box-shaped conductive portion including a male terminal insertion opening open toward the other end side and a rear opening window open toward the one end side, one of the pair of contact point forming fittings including a first fixing portion to be fixed to one of the pair of facing inner surfaces of the box-shaped conductive portion and a first spring piece cantilevered and held on the first fixing portion, the first spring piece projecting toward the rear opening window from the male terminal insertion opening, the other of the pair of contact point forming fittings including a second fixing portion to be fixed to the other of the pair of facing inner surfaces of the box-shaped conductive portion and a second spring piece cantilevered and held on the second fixing portion, the second spring piece projecting toward the rear opening window from the male terminal insertion opening, the first spring piece including a first contact point on a facing surface facing the second spring piece, the second spring piece including a second contact point on a facing surface facing the first spring piece, a contact pressure applying spring being arranged on projecting end parts of the respective first and second spring pieces, the contact pressure applying spring being sized to be insertable through the rear opening window, and the projecting end parts being biased in directions toward each other to press the first and second contact points into contact with the male terminal as the male terminal is press-fit between the facing surfaces of the first and second spring pieces.

### Effect of the Invention

According to a connector of the present disclosure, it is possible to suppress or hinder the transmission of an external force applied to a wire to a terminal side while suppressing the enlargement of the connector itself and an increase in manufacturing cost.

### BRIEF DESCRIPTION OF THE DRAWINGS

FIG. 1 is a perspective view showing a female terminal according to one embodiment in a state connected to a male terminal.

FIG. 2 is a plan view enlargedly showing an essential part of the female terminal shown in FIG. 1.

FIG. 3 is a section along III-III in FIG. 2.

FIG. 4 is a perspective view showing the female terminal shown in FIG. 1 in a state separated from the male terminal.

FIG. 5 is a vertical section, corresponding to FIG. 3, of the female terminal shown in FIG. 4.

FIG. 6 is a section along VI-VI in FIG. 5.

FIG. 7 is an exploded perspective view of the female terminal shown in FIG. 1.

FIG. 8 is a perspective view showing a body portion constituting the female terminal shown in FIG. 1 in an unfolded state before being bent.

FIG. 9 is a section along IX-IX in FIG. 8.

### DETAILED DESCRIPTION TO EXECUTE THE INVENTION

### Description of Embodiments of Present Disclosure

First, embodiments of the present disclosure are listed and described.
(1) The female terminal of the present disclosure is provided with a body portion including a connecting portion to be conductively connected to another member on one end side in a length direction and a hollow box-shaped conductive portion on the other end side in the length direction, and a pair of contact point forming fittings having a smaller plate thickness than the body portion, the pair of contact point forming fittings being conductively fixed and held on a pair of facing inner surfaces of the box-shaped conductive portion, the box-shaped conductive portion including a male terminal insertion opening open toward the other end side and a rear opening window open toward the one end side, one of the pair of contact point forming fittings including a first fixing portion to be fixed to one of the pair of facing inner surfaces of the box-shaped conductive portion and a first spring piece cantilevered and held on the first fixing portion, the first spring piece projecting toward the rear opening window from the male terminal insertion opening, the other of the pair of contact point forming fittings including a second fixing portion to be fixed to the other of the pair of facing inner surfaces of the box-shaped conductive portion and a second spring piece cantilevered and held on the second fixing portion, the second spring piece projecting toward the rear opening window from the male terminal insertion opening, the first spring piece including a first contact point on a facing surface facing the second spring piece, the second spring piece including a second contact point on a facing surface facing the first spring piece, a contact pressure applying spring being arranged on projecting end parts of the respective first and second spring pieces, the contact pressure applying spring being sized to be insertable through the rear opening window, and the projecting end parts being biased in directions toward each other to press the first and second contact points into contact with the male terminal as the male terminal is press-fit between the facing surfaces of the first and second spring pieces.

According to the female terminal of the present disclosure, the body portion includes the connecting portion and the box-shaped conductive portion, and the pair of contact point forming fittings having a smaller plate thickness than the body portion are conductively fixed and held on the pair of facing inner surfaces of the box-shaped conductive portion. In this way, if a large current needs to flow, the contact points with the male terminal can be formed by the contact point forming fittings thinner than the body portion while conduction resistance is reduced by making the plate thickness of the body portion larger. As a result, by the thin contact point forming fittings, followability to the male terminal can be ensured and the enlargement of the female terminal can be suppressed without making the first and second spring pieces longer. Further, since the first and second spring pieces are thinner than the body portion, reaction forces of the first and second spring pieces when being displaced to follow the male terminal can be reduced and the occurrence of a problem that the contact pressure applying spring is excessively deformed and a desired contact pressure cannot be ensured can be advantageously suppressed or hindered. In addition, since the body portion is thicker than the contact point forming fittings and rigidity can be advantageously ensured by the box-shape of the box-shaped conductive portion, a problem that the entire female terminal including the box-shaped conductive portion is deformed by the reaction forces of the first and second spring pieces when being displaced to follow the male terminal can also be advantageously suppressed or hindered.

Further, since the box-shaped conductive portion of the body portion includes the rear opening window and the contact pressure applying spring is sized to be insertable through the rear opening window, the contact pressure applying spring can be arranged on the projecting end parts of the first and second spring pieces through the rear opening window from a front side in a projecting direction. In this way, the assemblability of the female terminal is improved as compared to the conventional structure in which the contact pressure applying spring can be assembled only from a lateral side in a direction orthogonal to the projecting direction of the first and second spring pieces.
(2) Preferably, the contact pressure applying spring is constituted by a clip spring including a coupling plate portion in the form of a rectangular flat plate and a pair of sandwiching plate portions in the form of rectangular flat plates projecting in directions toward each other from both side edge parts of the coupling plate portion, and the projecting end part of the first spring piece and the projecting end part of the second spring piece are sandwiched between the pair of sandwiching plate portions of the clip spring during insertion of the male terminal. By adopting the clip spring as the contact pressure applying spring, the contact pressure applying spring capable of biasing the projecting end parts of the first and second spring pieces in the directions toward each other during the insertion of the male terminal can be configured to have a compact and simple structure while being enabled to be arranged on the projecting end parts of the first and second spring pieces.
(3) Preferably, the first fixing portion of the one contact point forming fitting is fixed to the one facing inner surface of the box-shaped conductive portion by welding and the second fixing portion of the other contact point forming fitting is fixed to the other facing inner surface of the box-shaped conductive portion by welding. Since the first and second fixing portions of the pair of contact point forming fittings are respectively fixed to the facing inner surfaces of the box-shaped conductive portion by welding, the conduction resistance of the female terminal can be advantageously reduced.
(4) Preferably, in (3) described above, the one contact point forming fitting is crimped and fixed to the one facing inner surface of the box-shaped conductive portion and the other contact point forming fitting is crimped and fixed to the other facing inner surface of the box-shaped conductive portion. By crimping and fixing the contact point forming fittings to the box-shaped conductive portion, the conduction resistance can be further reduced and the contact point forming fittings can be held on the box-shaped conductive portion with improved reliability.
(5) Preferably, the box-shaped conductive portion includes a positioning protrusion projecting on an inner surface and an inward insertion end position of the contact pressure applying spring in the box-shaped conductive portion through the rear opening window is defined by contact of the contact pressure applying spring with the positioning protrusion. Since the inward insertion end position of the contact pressure applying spring in the box-shaped conductive portion through the rear opening window is defined by the contact of the contact pressure applying spring with the positioning protrusion projecting on the inner surface of the box-shaped conductive portion, a worker can easily and stably arrange the contact pressure applying spring at a desired position by inserting the contact pressure applying spring through the rear opening window. In this way, the assemblability of the female terminal can be further improved.
(6) Preferably, a retainer is further provided which covers the rear opening window by being assembled with the box-shaped conductive portion. By assembling the retainer for covering the rear opening window with the box-shaped conductive portion, a problem that the contact pressure applying spring is detached through the rear opening window can be advantageously prevented and the configuration of the female terminal can be stably maintained.
(7) Preferably, in (6) described above, the retainer includes a displacement restricting portion for restricting a displacement of the contact pressure applying spring toward the rear opening window by being arranged in proximity to the contact pressure applying spring and contacting the contact pressure applying spring. By further providing the displacement restricting portion on the retainer for covering the rear opening window, it is possible to stably maintain the configuration of the female terminal in which the desired contact pressure by the contact pressure applying spring is stably maintained by restricting a displacement of the contact pressure applying spring toward the rear opening window.
(8) Preferably, the body portion is a press-worked product constituted by a single metal flat plate and the connecting portion has the same plate thickness as the metal flat plate. The conduction resistance having a desired value can be advantageously realized by configuring the entire body portion using the metal flat plate having a plate thickness corresponding to a required current capacity. Moreover, since the connecting portion has the same plate thickness as the metal flat plate and is not thickened by being folded or overlapping a plurality of member, an insert molding process of a connector housing or the like with the connecting portion inserted can be advantageously performed without any problem such as the entrance of a resin between overlapping surfaces.
(9) Preferably, in any one of (2) to (8) described above, a plurality of the first spring pieces and a plurality of the second spring pieces respectively arranged at a plurality of positions separated from each other in a plate width direction of the male terminal are included, the clip spring includes a plurality of pairs of the sandwiching plate portions respectively arranged at a plurality of positions separated from each other in the plate width direction, and the projecting end parts of the plurality of first spring pieces and the projecting end parts of the plurality of second spring pieces are respectively separately sandwiched by the plurality of pairs of sandwiching plate portions during insertion of the male terminal. The male terminal can be sandwiched by the plurality of first spring pieces and the plurality of second spring pieces arranged at the plurality of positions separated in the plate width direction of the male terminal. Moreover, pairs of the first and second spring pieces are sandwiched by the separate pairs of sandwiching plate portions arranged apart in the plate width direction. In this way, the stable followability of the female terminal to a rotational displacement of the male terminal can be advantageously realized.

### Details of Embodiment of Present Disclosure

A specific example of a female terminal of the present disclosure is described with reference to the drawings. Note that the present disclosure is not limited to these illustrations, but is represented by claims and includes all changes in the scope of claims and in the meaning and scope of equivalents.

### Embodiment

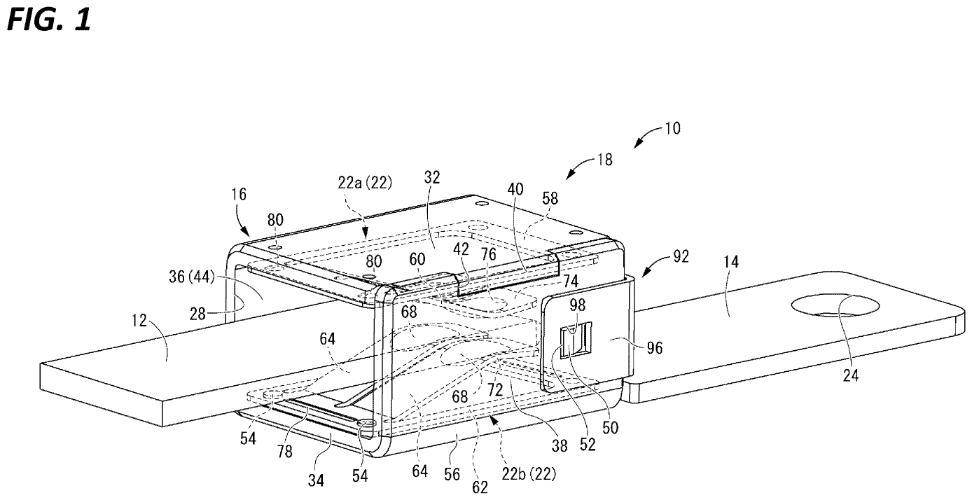

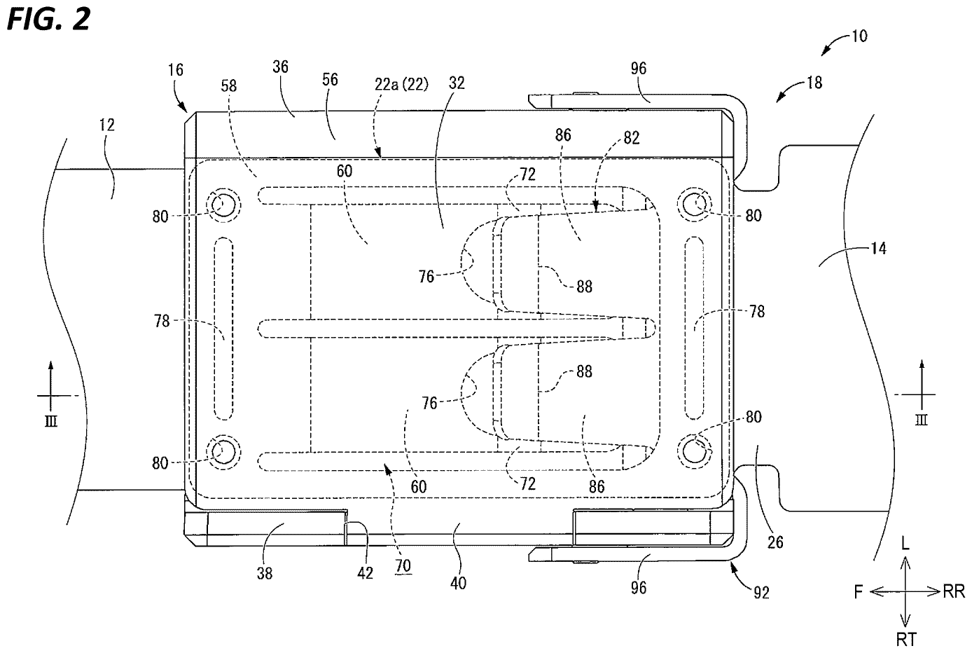

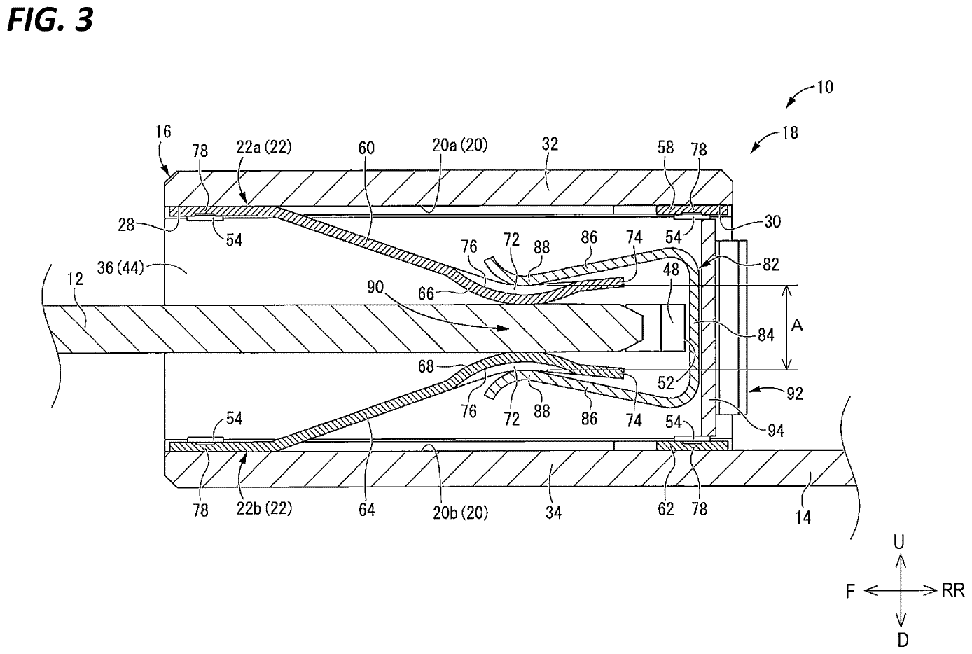

Hereinafter, a female terminal 10 of one embodiment of the present disclosure is described using FIGS. 1 to 9. The female terminal 10 is, for example, a terminal for connecting a member on a power supply side such as a battery and a member on a load side such as a motor. The female terminal 10 provided on one of the power supply side and the load side and a male terminal 12 provided on the other of the power supply side and the load side contact each other and are brought into a conductive state, whereby power is supplied from the power supply such as a battery to the load such as a motor. Note that the female terminal 10 can be arranged in an arbitration orientation, but upper and lower sides in FIG. 3 are referred to as upper and lower sides, left and right sides in FIG. 2 are referred to as front and rear sides, and upper and lower sides in FIG. 2 are referred to as left and right sides in the following description. Further, for a plurality of identical members, only some members may be denoted by a reference sign and the other members may not be denoted by the reference sign.

### (Female Terminal 10)

The female terminal 10 is provided with a body portion 18 including a connecting portion 14 to be conductively connected to another member (e.g. a member on the power supply side such as a battery) on one end side (rear end side) in a length direction and a hollow box-shaped conductive portion 16 on the other end side (front end side) in the length direction. Further, the female terminal 10 is provided with a pair of contact point forming fittings 22, 22 (first and second contact point forming fittings 22a, 22b to be described later) to be conductively fixed and held on a pair of facing inner surfaces 20, 20 (inner surfaces 20a, 20b of an upper wall portion 32 and a lower wall portion 34 to be described later) of the box-shaped conductive portion 16.

### (Male Terminal 12)

The male terminal 12 is a plate-like tab terminal as a whole. The male terminal 12 has a substantially rectangular shape in a plan view, has a predetermined width (lateral dimension) and a predetermined thickness (vertical dimension) and extends substantially straight in a front-rear direction. In this embodiment, the male terminal 12 has a laterally long shape with the width larger than the thickness. Note that an end part (rear end part) on a front side in an insertion direction into the female terminal 10 has a tapered shape. The male terminal 12 is electrically conductive and made of metal having a low electrical conductivity such as copper, copper alloy, aluminum or aluminum alloy. A bolt insertion hole is, for example, provided in a base end part (front end part) of the male terminal 12 and the male terminal 12 is fixed to another member (e.g. a member on the load side such as a motor) by an unillustrated bolt, or a wire on the load side is fixed or crimped thereto.

### (Connecting Portion 14)

The connecting portion 14 is substantially in the form of a plate extending in the front-rear direction as a whole and has a substantially rectangular shape with a front-rear dimension larger than a lateral dimension in a plan view. A rear end part of the connecting portion 14 is formed with a bolt insertion hole 24 penetrating in a plate thickness direction (vertical direction), and the female terminal 10 can be fixed to another member (e.g. a member on the power supply side such as a battery) by an unillustrated bolt inserted through the bolt insertion hole 24. Note that an end of a wire or the like may be fixed to the connecting portion 14 if a female connector is configured to include the female terminal 10, or a busbar or the like constituting an internal circuit may be connected to the connecting portion 14 if a terminal block is configured to include the female terminal 10. Further, the connecting portion 14 has relatively wide flat parts on upper and lower surfaces. In this way, an adhesive or the like is easily applied to these flat parts. For example, in forming the female connector or the terminal block configured to include the female terminal 10, the female connector or the terminal block including the female terminal 10 can be easily integrally molded by applying an adhesive or the like to the connecting portion 14 and performing molding with the female terminal 10 set in a molding cavity.

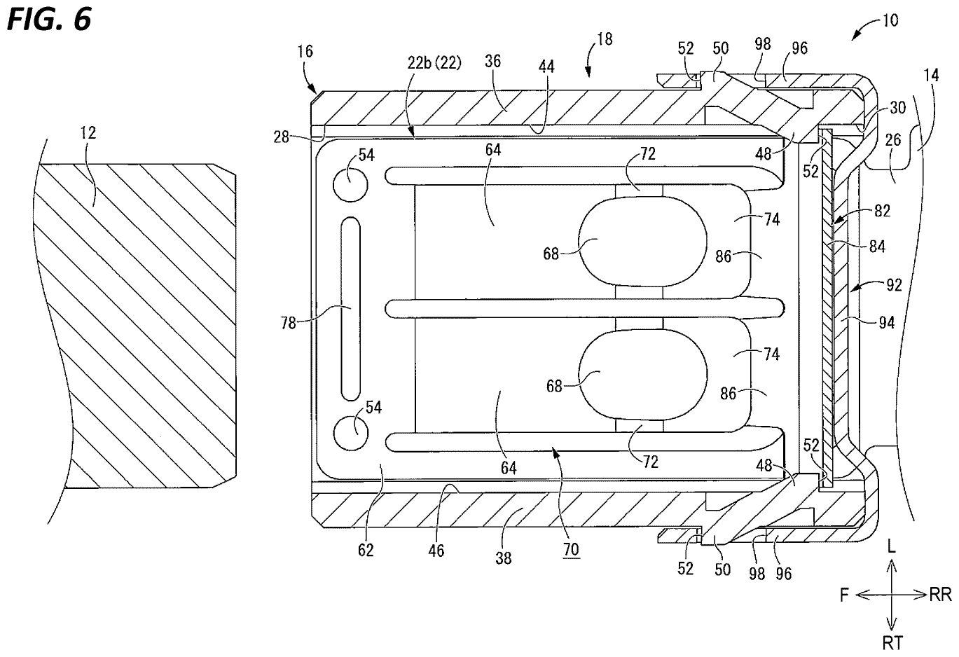

Note that, as described later, the body portion 18 including the connecting portion 14 and the box-shaped conductive portion 16 is a press-worked product formed by applying press working to a single metal flat plate. That is, the connecting portion 14 has the same plate thickness (vertical dimension) as the metal flat plate constituting the body portion 18. The box-shaped conductive portion 16 is integrally coupled in front of the connecting portion 14. As also shown in FIG. 6, a narrow portion 26 having a smaller width (lateral dimension) than the connecting portion 14 and the box-shaped conductive portion 16 is provided in a part coupling the connecting portion 14 and the box-shaped conductive portion 16 (front end part of the connecting portion 14). In this way, the metal flat plate can be easily press-worked.

### (Box-Shaped Conductive Portion 16)

The box-shaped conductive portion 16 is substantially in the form of a rectangular box or a rectangular tube open on both sides in the front-rear direction as a whole, and includes a male terminal insertion opening 28 open toward the other end side (front end side) in the length direction of the body portion 18 and a rear opening window 30 open toward the one end side (rear end side) in the length direction. In this embodiment, the box-shaped conductive portion 16 has a laterally long shape with a width (lateral dimension) larger than a height (vertical dimension). The box-shaped conductive portion 16 includes the upper wall portion 32 constituting a wall portion on an upper side, the lower wall portion 34 constituting a wall portion on a lower side and a left wall portion 34 and a right wall portion 38 constituting wall portions on both left and right sides. In this way, the upper and lower wall portions 32, 34 are facing each other in the vertical direction. In this embodiment, a pair of the facing inner surfaces 20, 20, on which the aforementioned pair of contact point forming fittings 22, 22 are fixed and held, are constituted by an inner surface 20a of the upper wall portion 32 and an inner surface 20b of the lower wall portion 34.

Note that, as described above, the body portion 18 including the connecting portion 14 and the box-shaped conductive portion 16 is formed by applying press working to the single metal flat plate. In this embodiment, the connecting portion 14 and the lower wall portion 34 are coupled to each other via the aforementioned narrow portion 26. Further, a fitting protrusion 40 projecting toward the right wall portion 38 is provided in an intermediate part in the front-rear direction of a right end part of the upper wall portion 32, and a fitting recess 42 open toward the upper wall portion 32 is provided in an intermediate part in the front-rear direction of an upper end part of the right wall portion 38. A length (front-rear dimension) of the fitting protrusion 40 is substantially equal to or slightly larger than a length (front-rear dimension) of the fitting recess 42. In this way, when the box-shaped conductive portion 16 is configured, such as by press-working the metal flat plate, the upper wall portion 32 and the right wall portion 38 can be prevented from being accidentally separated at the time of forming the box-shaped conductive portion 16 by substantially press-fitting the fitting protrusion 40 of the upper wall portion 32 into the fitting recess 42 of the right wall portion 38.

Further, the left and right wall portions 36, 38 are facing each other in the lateral direction. As also shown in FIG. 6, positioning protrusions 48 projecting inward in a facing direction (laterally inward) are provided on an inner surface 44 of the left wall portion 36 and an inner surface 46 of the right wall portion 38 constituting the inner surface of the box-shaped conductive portion 16. Further, locking protrusions 50 projecting outward in the facing direction (laterally outward) are provided in front of the respective positioning protrusions 48 on the left and right wall portions 36, 38. The rear end surfaces of these positioning protrusions 48 and the front end surfaces of these locking protrusions 50 respectively serve as vertical surfaces 52 spreading in a direction perpendicular to the front-rear direction.

### (Body Portion 18)

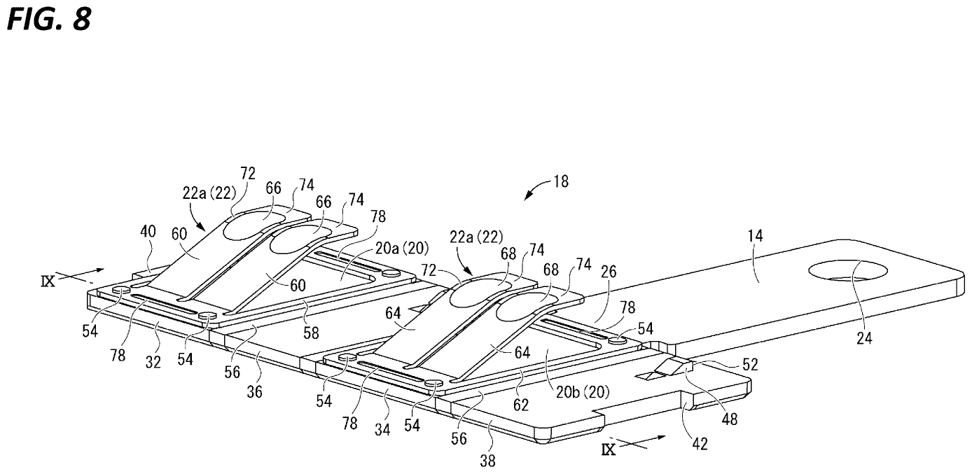

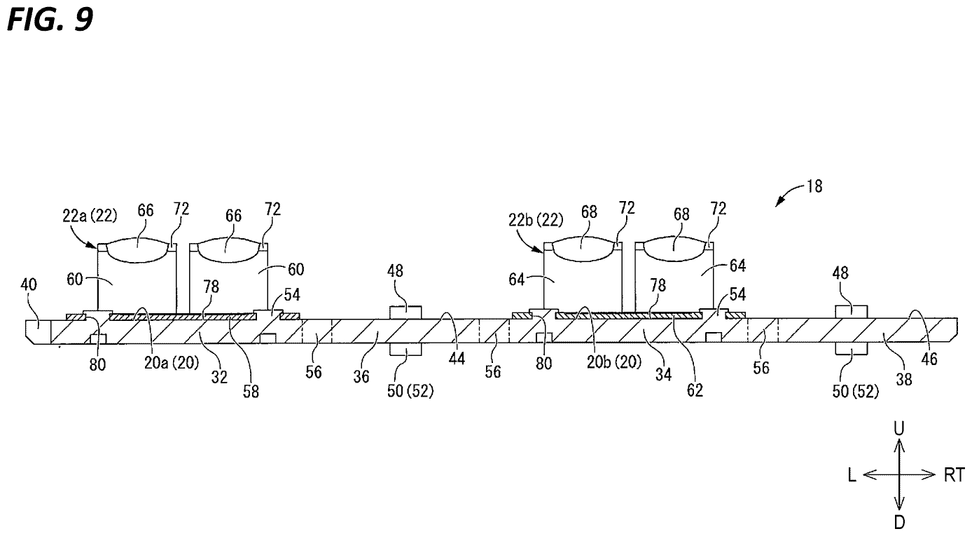

Here, as described above, the body portion 18 including the connecting portion 14 and the box-shaped conductive portion 16 is a press-worked product formed by applying press working to the single metal flat plate. The body portion 18 (metal flat plate) before press working is applied is shown in an unfolded state in FIGS. 8 and 9. As shown in FIGS. 8 and 9, the pair of contact point forming fittings 22, 22 are fixed and held on the respective inner surfaces 20a, 20b of the upper and lower wall portions 32, 34 of the body portion 18 in a state before press working is applied. A method for fixing the respective contact point forming fittings 22 to the respective inner surfaces 20a, 20b is not limited. In this embodiment, the respective contact point forming fittings 22 are fixed to the respective inner surfaces 20a, 20b by welding and crimping as described later. Thus, engaging protrusions 54 for crimping and fixing each contact point forming fitting 22 are provided on four corners of each inner surface 20a, 20b. The respective engaging protrusions 54 project inward in the vertical direction in a formed state of the box-shaped conductive portion 16 shown in FIG. 1 and the like, and project upward from the respective inner surfaces 20a, 20b of the upper and lower wall portions 32, 34 in the unfolded state of the body portion 18 shown in FIGS. 8 and 9.

Further, as shown in FIGS. 8 and 9, in the unfolded state of the body portion 18, the upper, left, lower and right wall portions 32, 36, 34 and 38 constituting the box-shaped conductive portion 16 are continuous in the lateral direction, and the connecting portion 14 extends rearward via the narrow portion 26 from the lower wall portion 34. Bending portions 56 are provided between the upper and left wall portions 32, 36, between the left and lower wall portions 36, 34 and between the lower and right wall portions 34, 38. The box-shaped conductive portion 16 is configured in a front part of the body portion 18 by bending the respective bending portions 56 and fitting the fitting protrusion 40 and the fitting recess 42. Therefore, in this embodiment, any of the upper, left, lower and right wall portions 32, 36, 34 and 38 constituting the box-shaped conductive portion 16 has a substantially constant plate thickness. A metal material constituting the body portion 18 is not limited, but a metal excellent in electrical conductivity can be adopted and, for example, pure copper can be adopted.

### (Contact Point Forming Fittings 22)

As described above, the pair of contact point forming fittings 22, 22 are fixed and held on the inner surface 20a of the upper wall portion 32 and the inner surface 20b of the lower wall portion 34 and include the first contact point forming fitting 22a to be fixed to the inner surface 20a of the upper wall portion 32 as one of the pair of contact point forming fittings 22, 22 and the second contact point forming fitting 22b to be fixed to the inner surface 20b of the lower wall portion 34 as the other of the pair of contact point forming fittings 22, 22. Note that, to facilitate understanding, the first and second contact point forming fittings 22a, 22b accommodated and arranged inside the box-shaped conductive portion 16 are respectively shown in broken lines in FIGS. 1, 4 and 7. Further, the first contact point forming fitting 22a and a clip spring 82 accommodated and arranged inside the box-shaped conductive portion 16 serving as a contact pressure applying spring to be described later are respectively shown in broken lines in FIG. 2.

The first contact point forming fitting 22a includes a first fixing portion 58 to be fixed to the inner surface 20a of the upper wall portion 32 and first spring pieces 60 cantilevered and held on the first fixing portion 58 and projecting from the male terminal insertion opening 28 toward the rear opening window 30, i.e. from a front side toward a rear side. Further, the second contact point forming fitting 22b includes a second fixing portion 62 to be fixed to the inner surface 20b of the lower wall portion 34 and second spring pieces 64 cantilevered and held on the second fixing portion 62 and projecting from the male terminal insertion opening 28 toward the rear opening window 30, i.e. from the front side toward the rear side. These first and second spring pieces 60, 64 are facing each other in the vertical direction, the first spring pieces 60 include first contact points 66 on facing surfaces (lower surfaces) facing the second spring pieces 64, and the second spring pieces 64 include second contact points 68 on facing surfaces (upper surfaces) facing the first spring pieces 60.

In this embodiment, the first spring pieces 60, 60 are provided at a plurality of positions (two positions) separated from each other in a plate width direction (lateral direction) of the male terminal 12 in the first contact point forming fitting 22a, and the second spring pieces 64, 64 are provided at a plurality of positions (two positions) separated from each other in the plate width direction (lateral direction) of the male terminal 12 in the second contact point forming fitting 22b.

The specific shapes of the first and second contact point forming fittings 22a, 22b are described below. Since the first and second contact point forming fittings 22a, 22b have the same shape, the first contact point forming fitting 22a is described and description on the second contact point forming fitting 22b is omitted. That is, the first and second fixing portions 58, 62 are shaped to match each other, and the respective first spring pieces 60 and the respective second spring pieces 64 are shaped to match each other. An electrically conductive and springy metal can be adopted as a material of the first and second contact point forming fittings 22a, 22b and, for example, a copper alloy can be adopted.

The first contact point forming fitting 22a is constituted by a substantially rectangular plate-like body as a whole and has a plate thickness smaller than the metal flat plate constituting the body portion 18. A central part of the substantially rectangular plate-like body is cut and raised toward one side in the plate thickness direction, the substantially frame-like first fixing portion 58 is provided in an outer peripheral part and a pair of the first spring pieces 60, 60 are constituted by the cut and raised part. That is, in the first contact point forming fitting 22a, a gap 70 is formed on three sides (rear side and both left and right sides) around each first spring piece 60 and a front end part of each first spring piece 60 is coupled to the first fixing portion 58 in the outer peripheral part of the first contact point forming fitting 22a. In other words, each first spring piece 60 extends rearward from a front end part of the first fixing portion 58 and projects more toward the one side in the plate thickness direction toward the rear side. In this way, each first spring piece 60 is resiliently deformable in the plate thickness direction in the first contact point forming fitting 22a.

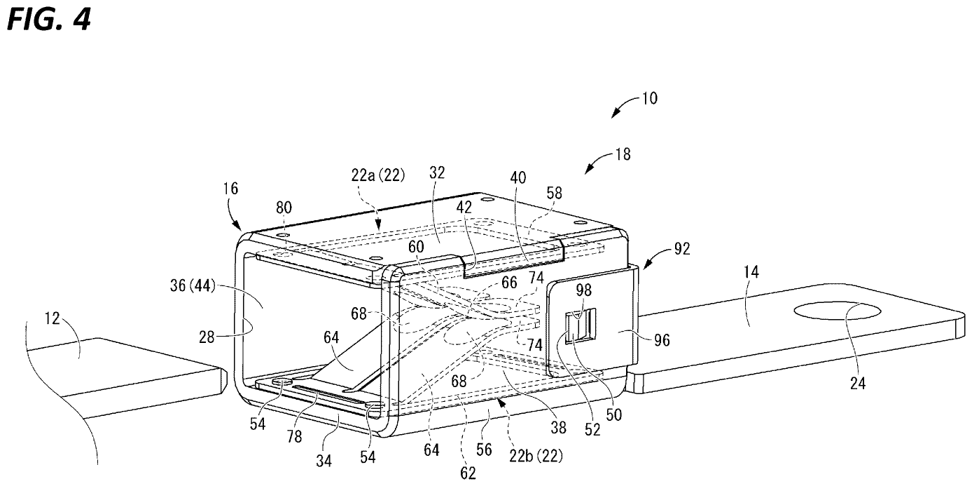

Further, a bent portion 72 is provided in a projecting tip part of each first spring piece 60, and an inclination angle to the first fixing portion 58 in each first spring piece 60 is made smaller in the bent portion 72. Specifically, by providing the bent portion 72 in the projecting tip part of each first spring piece 60, a projecting end part 74 (rear end part) of each first spring piece 60 spreads in the same horizontal direction (direction orthogonal to the vertical direction) as the first fixing portion 58 and the upper wall portion 32 as also shown in FIGS. 4, 5 and 8 in a natural state of each first spring piece 60 before the insertion of the male terminal 12.

The first contact point 66 convex toward the one side in the plate thickness direction of the first contact point forming fitting 22a, which is a raising direction of each first spring piece 60, is provided at the formation position of the bent portion 72 in each first spring piece 60. This first contact point 66 has a curved arcuate shape in a vertical section shown in FIG. 3, has a predetermined lateral dimension in a lateral central part of each first spring piece 60 and is provided over both sides across the bent portion 72 in each first spring piece 60. Each such a first contact point 66 has an oval shape with a dimension in the front-rear direction, which is the insertion direction of the male terminal 12, larger than a lateral dimension in a plan view (projection in the vertical direction). In this way, even if the male terminal 12 inserted into the female terminal 10 is pivotally displaced in the vertical direction, contact areas between the respective first and second contact points 66, 68 and the male terminal 12 can be stably ensured. In this embodiment, each first contact point 66 is formed by press-working each first spring piece 60, and a recess 76 is formed at a position corresponding to the first contact point 66 on the other side in the plate thickness direction of each first spring piece 60.

As described above, the substantially rectangular frame-like first fixing portion 58 is overlapped on the inner surface 20a of the upper wall portion 32 and fixed by welding and crimping. In this embodiment, the first fixing portion 58 is fixed to the inner surface 20a of the upper wall portion 32 in both front and rear end parts. Particularly, in this embodiment, lateral central parts of the both front and rear end parts of the first fixing portion 58 are fixed to the inner surface 20a of the upper wall portion 32 in regions over a predetermined lateral dimension by laser welding. In this way, welded portions 78 are formed in the lateral central parts of the both front and rear end parts of the first fixing portion 58. Similarly, welded portions 78 are formed in lateral central parts of both front and rear end parts of the second fixing portion 62 and the second fixing portion 62 is overlapped on the inner surface 20b of the lower wall portion 34 and fixed by laser welding.

Further, as also shown in FIGS. 2 and 9, engaging holes 80 corresponding to the engaging protrusions 54 provided on the four corners of the inner surface 20a of the upper wall portion 32 are formed to penetrate through the first fixing portion 58 in the vertical direction in both end parts in the lateral direction of the both front and rear end parts of the first fixing portion 58. An inner diameter of each engaging hole 80 is substantially equal to or slightly larger than an outer diameter of each engaging protrusion 54, and each engaging protrusion 54 is insertable into each engaging hole 80. As shown in FIG. 9, after each engaging protrusion 54 is inserted into each engaging hole 80, a projecting tip part of each engaging protrusion 54 projecting from each engaging hole 80 is hit and flattened to make an outer diameter of the part of each engaging protrusion 54 projecting from each engaging hole 80 larger than the inner diameter of each engaging hole 80. In this way, the first fixing portion 58 (first contact point forming fitting 22a) is fixed and held on the inner surface 20a of the upper wall portion 32 also by crimping in addition to laser welding. Similarly, engaging holes 80 are formed in both end parts in the lateral direction of the both front and rear end parts of the second fixing portion 62, and the second fixing portion 62 (second contact point forming fitting 22b) is fixed and held on the inner surface 20b of the lower wall portion 34 also by crimping in addition to laser welding.

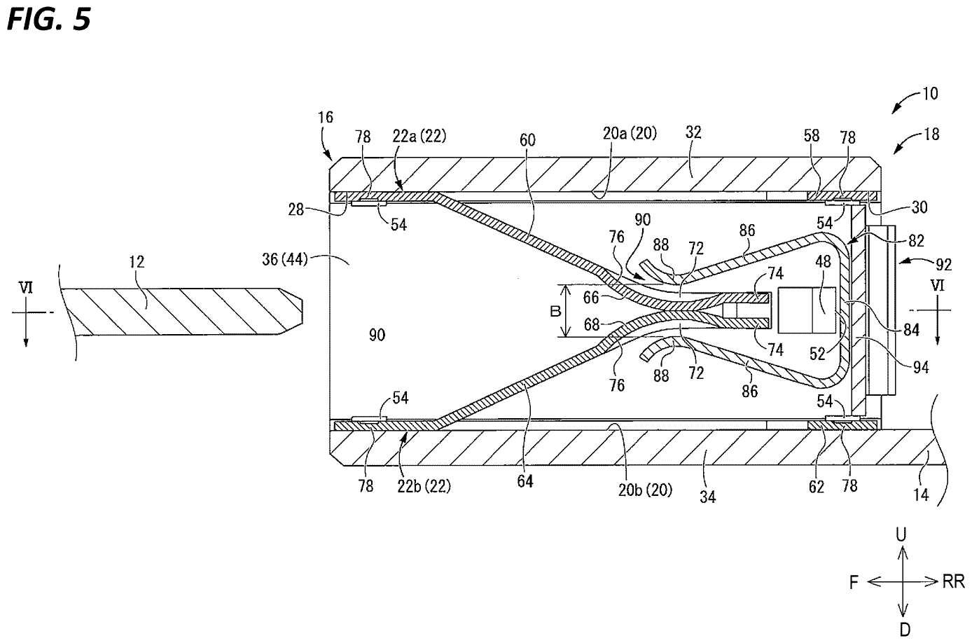

As shown in FIGS. 8 and 9, the first and second contact point forming fittings 22a, 22b shaped as described above are fixed to the respective inner surfaces 20a, 20b of the upper and lower wall portions 32, 34 in the body portion 18 (metal flat plate) before being bent. That is, in the first and second contact point forming fittings 22a, 22b, each first spring piece 60 and each second spring piece 64 are cut and raised in directions separating from the upper and lower wall portions 32, 34. As shown in FIGS. 4 and 5, the body portion 18 is bent to configure the box-shaped conductive portion 16, whereby the upper and lower wall portions 32, 34 face each other in the vertical direction and each first spring piece 60 and each second spring piece 64 are cut and raised in directions toward each other in the first and second contact point forming fittings 22a, 22b. In this way, as shown in FIG. 5, the projecting end parts 74 of each first spring piece 60 and each second spring piece 64 are proximate to each other in the vertical direction. In this embodiment, the first and second contact points 66, 68 respectively projecting in the raising directions in each first spring piece 60 and each second spring piece 64 are in contact with each other.

### Contact Pressure Applying Spring (Clip Spring 82)

The female terminal 10 is provided with the clip spring 82 serving as the contact pressure applying spring to be arranged on the projecting end parts 74 of the respective first spring pieces 60 and the respective second spring pieces 64. By inserting the male terminal 12 into the female terminal 10, the projecting end parts 74 of the respective first spring pieces 60 and the respective second spring pieces 64 are biased in directions toward each other by the clip spring 82. This clip spring 82 is formed in a size to be insertable through the rear opening window 30 in the box-shaped conductive portion 16.

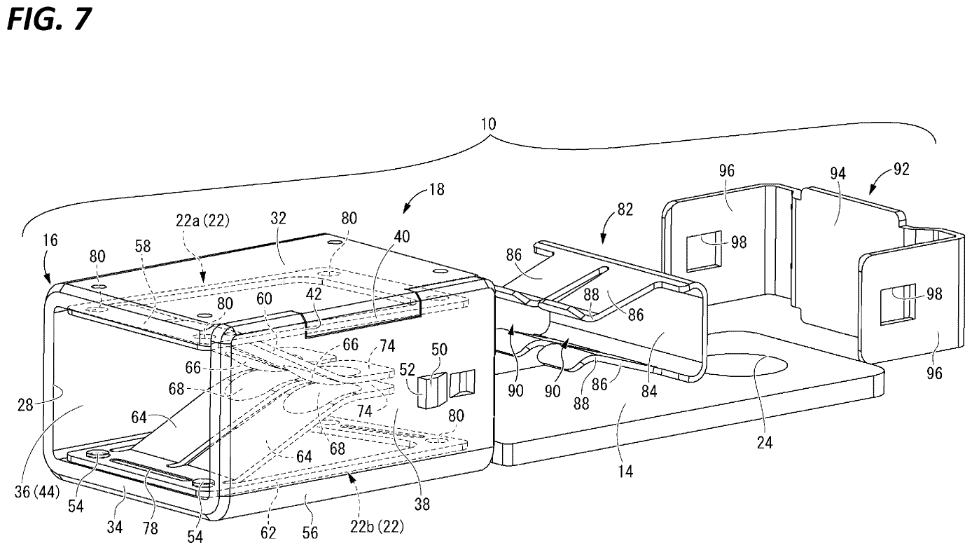

Specifically, the clip spring 82 includes a coupling plate portion 84 in the form of a rectangular plate and a pair of sandwiching plate portions 86, 86 in the form of rectangular plates projecting in directions toward each other (inward in the vertical direction) from both side edge parts (both upper and lower side edge parts) of the coupling plate portion 84 as also shown in FIG. 7. In this embodiment, a plurality of (two) sandwiching plate portions 86, 86 separated from each other in the lateral direction, which is the plate width direction of the male terminal 12, are provided on each of both sides of the coupling plate portion 84, and a total of four sandwiching plate portions 86 are provided in the clip spring 82. That is, another pair of the sandwiching plate portions 86, 86 facing each other in the vertical direction are provided at a position separated in the lateral direction. These sandwiching plate portions 86 are resiliently deformable in the vertical direction.

Note that lateral dimensions of the respective sandwiching plate portions 86 are larger than those of the respective recesses 76 provided on vertically outer sides of the respective first spring pieces 60 and the respective second spring pieces 64. In this way, when the male terminal 12 is inserted into the female terminal 10 and bent parts 88 of the respective sandwiching plate portions 86 contact the respective first spring pieces 60 and the respective second spring pieces 64 at the formation positions of the respective recesses 76 as shown in FIG. 3, both end parts in the lateral direction of the respective sandwiching plate portions 86 contact parts laterally outward of the respective recesses 76 in the respective first spring pieces 60 and the respective second spring pieces 64.

The bent parts 88 are provided in intermediate parts in a length direction of the respective sandwiching plate portions 86, and projecting tip parts of the respective sandwiching plate portions 86 extend in directions separating from the bent parts 88. Accordingly, a facing distance between the respective sandwiching plate portions 86 facing each other in the vertical direction is smallest at the bent parts 88 provided in the intermediate parts in the length direction. A gap between these bent parts 88 serves as an insertion opening 90, through which the respective projecting end parts 74 of the first and second spring pieces 60, 64 are inserted to be assembled.

As also shown in FIG. 5, an opening dimension (vertical dimension) of each insertion opening 90 before the resilient deformation of the clip spring 82 is larger than a vertical dimension of the projecting tip parts of each first spring piece 60 and each second spring piece 64. Such a clip spring 82 is inserted into the box-shaped conductive portion 16 through the rear opening window 30 of the box-shaped conductive portion 16. The projecting tip parts of each first spring piece 60 and each second spring piece 64 are inserted into each insertion opening 90 without the projecting tip parts of each first spring piece 60 and each second spring piece 64 contacting the respective bent parts 88 located most vertically inward in the respective sandwiching plate portions 86 or while each bent part 88 on an upper side, for example, contacts (slides in contact with) the projecting tip part of each first spring piece 60. An inward insertion end position of this clip spring 82 in the box-shaped conductive portion 16 through the rear opening window 30 is defined by the contact of both left and right end parts of the coupling plate portion 84 with the vertical surfaces 52 on the rear ends of the respective positioning protrusions 48 provided on the respective inner surfaces 44, 46 of the left and right wall portions 36, 38 as also shown in FIGS. 5 and 6.

Note that, as shown in FIGS. 5 and 6, the vertical dimension of each insertion opening 90 is larger than that of the projecting tip parts of each first spring pieces 60 and each second spring piece 64 to be inserted in the female terminal 10 before the insertion of the male terminal 12. Further, a distance in the front-rear direction between the respective positioning protrusions 48 (vertical surfaces 52) and a retainer 92 to be described later is slightly larger than a thickness (front-rear dimension) of the coupling plate portion 84, and a distance in the facing direction between the respective inner surfaces 44, 46 of the left and right wall portions 36, 38 is slightly larger than a width (lateral dimension) of the coupling plate portion 84. In this way, in the female terminal 10 before the insertion of the male terminal 12, the clip spring 82 is arranged in a free state without being fixed to the box-shaped conductive portion 16 in each of the vertical direction, the front-rear direction and the lateral direction.

### (Retainer 92)

The female terminal 10 is further provided with the retainer 92 for covering the rear opening window 30 and preventing the detachment of the clip spring 82 by being assembled with the box-shaped conductive portion 16. As also shown in FIG. 7, the retainer 92 is configured by bending a substantially strip-like member by press working or the like. The retainer 92 can be, for example, made of metal or synthetic resin, has preferably sufficient strength (deformation stiffness) and heat resistance, and is made of stainless steel in this embodiment.

The retainer 92 is a member extending in the lateral direction as a whole and provided, in a central part in the length direction, with a displacement restricting portion 94 for restricting a displacement of the clip spring 82 toward the rear opening window 30 by being arranged in proximity to the clip spring 82 and contacting the clip spring 82 during the assembly of the female terminal 10. The displacement restricting portion 94 has a substantially rectangular shape in a front view (view in the front-rear direction), and is slightly smaller than the rear opening window 30. In this way, when the retainer 92 is assembled with the box-shaped conductive portion 16, the displacement restricting portion 94 enters the box-shaped conductive portion 16 through the rear opening window 30 and covers the rear opening window 30 substantially entirely as also shown in FIGS. 5 and 6.

Further, both end parts in the lateral direction of the retainer 92 are bent to extend forward with respect to the displacement restricting portion 94, and fixing portions 96 for fixing the retainer 92 to the box-shaped conductive portion 16 are constituted by these forward extending parts of the both end parts in the lateral direction of the retainer 92. A substantially rectangular locking hole 98 penetrating in a thickness direction (lateral direction) is formed in a front part of each fixing portion 96, and the retainer 92 is assembled with the box-shaped conductive portion 16 by bringing the retainer 92 closer to the box-shaped conductive portion 16 from behind and locking the respective locking protrusions 50 projecting laterally outward on the box-shaped conductive portion 16 into the respective locking holes 98.

### (Assembly of Female Terminal 10)

Hereinafter, a specific example of an assembly method of the female terminal 10 is described. Note that the assembly method of the female terminal 10 is not limited to the one described below.

First, the metal flat plate for constituting the body portion 18 is prepared, and the first and second contact point forming fittings 22a, 22b are respectively fixed to parts for constituting the inner surfaces 20a, 20b of the upper and lower wall portions 32, 34 in this metal flat plate by welding and crimping. That is, the respective engaging protrusions 54 projecting from the respective inner surfaces 20a, 20b are inserted into the respective engaging holes 80 in the first and second fixing portions 58, 62, and the first and second contact point forming fittings 22a, 22b are positioned with respect to the respective inner surfaces 20a, 20b. Thereafter, the respective welded portions 78 in the first and second fixing portions 58, 62 are laser-welded with the upper and lower wall portions 32, 34 and the first and second fixing portions 58, 62 respectively overlapped. Then, the projecting tip parts of the respective engaging protrusions 54 projecting from the respective engaging holes 80 are hit and flattened, whereby the first and second contact point forming fittings 22a, 22b are fixed to the metal flat plate for constituting the body portion 18 as shown in FIGS. 8 and 9.

Subsequently, from the state shown in FIGS. 8 and 9, the respective bending portions 56 are bent and the fitting protrusion 40 provided on the upper wall portion 32 is fit into the fitting recess 42 in the right wall portion 38. In this way, the box-shaped conductive portion 16 is configured in the front part of the body portion 18. In this state, as shown in FIGS. 4 and 5, the respective projecting end parts 74 of the respective first and second spring pieces 60, 64 are proximate to each other in the vertical direction and the respective first contact points 66 of the respective first spring pieces 60 and the respective second contact points 68 of the respective second spring pieces 64 are in contact with each other.

In the box-shaped conductive portion 16 as described above, the clip spring 82 is inserted into the box-shaped conductive portion 16 through the rear opening window 30. The clip spring 82 is inserted until the coupling plate portion 84 comes into contact with the vertical surfaces 52 of the respective positioning protrusions 48 projecting laterally inward in the box-shaped conductive portion 16. In this way, the respective projecting end parts 74 of the respective first and second spring pieces 60, 64 are inserted into the respective insertion openings 90 in the clip spring 82. In this state, the bent parts 88 of the respective sandwiching plate portions 86 are not in contact with the respective first and second spring pieces 60, 64. Alternatively, for example, the clip spring 82 is displaced downward by gravity from the state shown in FIG. 5, the upper bent parts 88 come into contact with the respective first spring pieces 60 and the lower bent parts 88 are separated from the respective second spring pieces 64.

Thereafter, the retainer 92 is brought closer to the box-shaped conductive portion 16 from behind, the displacement restricting portion 94 is inserted into the box-shaped conductive portion 16 through the rear opening window 30 and the respective locking protrusions 50 of the box-shaped conductive portion 16 are locked into the respective locking holes 98 of the respective fixing portions 96. In this way, the retainer 92 is assembled with the box-shaped conductive portion 16 and the female terminal 10 is completed.

The male terminal 12 is press-fit into the female terminal 10 assembled in this way through the male terminal insertion opening 28 in the front part of the box-shaped conductive portion 16. In this way, as shown in FIG. 3, the first contact points 66 of the respective first spring pieces 60 and the second contact points 68 of the second spring pieces 64 come into contact with the both upper and lower surfaces of the male terminal 12, and the respective first spring pieces 60 and the respective second spring pieces 64 are pushed and expanded in directions separating from each other. Then, the bent portions 72 of the respective first spring pieces 60 and the respective second spring pieces 64 pushed and expanded vertically outward come into contact with the respective bent parts 88 of the clip spring 82 from vertically inner sides and the respective sandwiching plate portions 86 are resiliently deformed outward in the vertical direction. By resilient restoring forces of these sandwiching plate portions 86, the projecting end parts 74 of the respective first and second spring pieces 60, 64 are sandwiched by the respective sandwiching plate portions 86 and biased in the directions toward each other. In this way, the respective first contact points 66 and the respective second contact points 68 are pressed into contact with the both upper and lower surfaces of the male terminal 12 press-fit between the facing surfaces of the respective first and second spring pieces 60, 64. As a result, the male terminal 12 and the female terminal 10 are electrically conductively connected.

That is, a vertical distance A (see FIG. 3) between the respective bent portions 72 of the respective first and second spring pieces 60, 64 pressed into contact with the male terminal 12 from both upper and lower sides is larger than a vertical distance B (see FIG. 5) of each insertion opening 90 of the clip spring 82 in the natural state. As a result, as the male terminal 12 is inserted, not only the respective first and second spring pieces 60, 64, but also the respective sandwiching plate portions 86 of the clip spring 82 are pushed and expanded outward in the vertical direction, and the respective first and second contact points 66, 68 are pressed into contact with the both upper and lower surfaces of the male terminal 12 by resilient restoring forces of these sandwiching plate portions 86. Particularly, in this embodiment, the pair of first spring pieces 60, 60 separated from each other in the lateral direction and the pair of second spring pieces 64, 64 separated from each other in the lateral direction are provided, and the pair of sandwiching plate portions 86, 86 separated from each other in the lateral direction are provided on each of the both upper and lower sides of the clip spring 82. In this way, the sandwiching plate portions 86, 86 on the upper and lower sides sandwich the first spring piece 60 and the second spring piece 64 and the first and second contact points 66, 68 are pressed into contact with the male terminal 12 separately on each of both sides in the lateral direction.

According to the female terminal 10 of this embodiment, the first contact point forming fitting 22a constituting the respective first contact points 66 and the second contact point forming fitting 22b constituting the respective second contact points 68 are provided separately from the body portion 18 including the box-shaped conductive portion 16, and fixed to the facing inner surfaces (inner surfaces 20a, 20b of the upper and lower wall portions 32, 34) in the box-shaped conductive portion 16. In this way, the members constituting the contact points (first and second contact point forming fittings 22a, 22b) can be formed to be thin and short and the female terminal 10 can be reduced in size as compared to the case where contact points are formed by bending a metal flat plate like the conventional structure. Further, since the metal flat plate having the predetermined thickness can be adopted for the body portion 18 including the box-shaped conductive portion 16, larger currents can be dealt with and both an improvement in current capacity and the enlargement avoidance of the terminal can be achieved. By separately providing the first and second contact point forming fittings 22a, 22b and the box-shaped conductive portion 16, different materials can be adopted respectively for those. In this way, it is not necessary to adopt a springy material for the box-shaped conductive portion 16 and pure copper or the like excellent in electrical conductivity can be adopted as the material of the box-shaped conductive portion 16.

Further, since each first contact point 66 and each second contact point 68 are constituted by the first and second contact point forming fittings 22a, 22b having a relatively small plate thickness, each first spring piece 60 and each second spring piece 64 can be relatively flexibly deformed and followability to the displacement of the male terminal 12 can be improved also when the male terminal 12 is displaced with respect to the female terminal 10. Further, by reducing displacement amounts of these first and second spring pieces 60, 64, an influence on the clip spring 82 for applying biasing forces to each first spring piece 60 and each second spring piece 64 can be reduced. In this way, inward biasing forces in the facing direction generated by the resilient deformation of the clip spring 82 can be stably applied to each first contact point 66 and each second contact pint 68 as contact pressures with the male terminal 12. In addition to reducing the displacement amounts of each first spring piece 60 and each second spring piece 64, the box-shaped conductive portion 16 has sufficient deformation stiffness, wherefore a problem of deforming the entire female terminal 10 according to the displacement of the male terminal 12 is also avoided.

In addition to that, the clip spring is assembled from the lateral side in the conventional structure, whereas the clip spring 82 is assembled from behind through the rear opening window 30 of the box-shaped conductive portion 16 in the female terminal 10 of this embodiment. Particularly, the clip spring is assembled with the opening widened in the conventional structure, whereas the vertical dimension of the respective projecting end parts 74 of each first spring piece 60 and each second spring piece 64 is smaller than the opening dimension of the insertion opening 90 in the clip spring 82 and the clip spring 82 can be assembled without widening the opening in this embodiment. In this way, workability in assembling the clip spring 82 is improved.

The clip spring 82 is adopted as the contact pressure applying spring for applying contact pressures to each first spring piece 60 and each second spring piece 64 during the insertion of the male terminal 12. In this way, the clip spring 82 can be assembled with each first spring piece 60 and each second spring piece 64 by inserting the respective projecting end parts 74 of each first spring piece 60 and each second spring piece 64 into the insertion opening 90 of the clip spring 82. Particularly, before the insertion of the male terminal 12, the clip spring 82 is arranged in the free state with respect to the box-shaped conductive portion 16 in each of the vertical direction, the front-rear direction and the lateral direction. In this way, for example, even if the male terminal 12 is obliquely inserted into the female terminal 10, the clip spring 82 can be displaced according to the inclination of the male terminal 12 and stably apply contact pressures to each first spring piece 60 and each second spring piece 64.

The first fixing portion 58 of the first contact pressure forming fitting 22a is fixed to the inner surface 20a of the upper wall portion 32 by welding, and the second fixing portion 62 of the second contact pressure forming fitting 22b is fixed to the inner surface 20b of the lower wall portion 34 by welding. Particularly, by adopting laser welding as a welding method, regions required to be welded can be made smaller and the first and second contact pressure forming fittings 22a, 22b and, consequently, the female terminal 10 can be reduced in size.

The first fixing portion 58 of the first contact pressure forming fitting 22a is fixed to the inner surface 20a of the upper wall portion 32 also by crimping, and the second fixing portion 62 of the second contact pressure forming fitting 22b is fixed to the inner surface 20b of the lower wall portion 34 also by crimping. In this way, the first and second fixing portions 58, 62 are physically (structurally) fixed to the respective inner surfaces 20a, 20b not only by welding, but also by crimping. Thus, the detachment of the first and second contact pressure forming fittings 22a, 22b from the box-shaped conductive portion 16 is more effectively prevented.

The respective positioning protrusions 48 are provided on the inner surface of the box-shaped conductive portion 16 (inner surfaces 44, 46 of the left and right wall portions 36, 38), and the insertion end of the clip spring 82 through the rear opening window 30 of the clip spring 82 is defined by the contact of the respective positioning protrusions 48 and the clip spring 82. In this way, the clip spring 82 can be assembled with the box-shaped conductive portion 16 without being accompanied by a particularly cumbersome operation, and assemblability is further improved.

The retainer 92 for covering the rear opening window 30 is assembled with the box-shaped conductive portion 16. In this way, the detachment of the clip spring 82 through the rear opening window 30 is prevented. Particularly, the retainer 92 includes the displacement restricting portion 94 to be arranged in proximity to the clip spring 82, and a rearward displacement of the clip spring 82 is restricted by the contact of the clip spring 82 with the displacement restricting portion 94. As a result, the clip spring 82 can be stably arranged at a predetermined position inside the box-shaped conductive portion 16.

The body portion 18 is the press-worked product constituted by the single metal flat plate, and the connecting portion 14 has the same plate thickness as the metal flat plate. In this way, the connecting portion 14 is configured as one plate member, for example, without folding the metal flat plate or overlapping a plurality of members. Thus, the entrance of a resin material or an adhesive between overlapping surfaces and the like can be avoided at the time of insert molding or the like, and a female connector or a terminal block including the female terminal 10 can be more easily formed by integral molding.

The pair of first spring pieces 60, 60 are provided apart from each other in the lateral direction in the first contact pressure forming fitting 22a, and the pair of second spring pieces 64, 64 are provided apart from each other in the lateral direction in the second contact pressure forming fitting 22b. Further, in the clip spring 82, the two sandwiching plate portions 86 are provided apart from each other in the lateral direction on each of the both upper and lower sides of the coupling plate portion 84. In this way, contact pressures can be applied to the first and second spring pieces 60, 64 by the upper and lower sandwiching plate portions 86 separately on each of the both left and right sides. As a result, even if the male terminal 12 is, for example, rotationally displaced about a center axis extending in the front-rear direction after the insertion of the male terminal 12 into the female terminal 10, the occurrence of a problem that contact pressures are not sufficiently applied on either one of the left and right sides can be avoided.

### Modifications

Although the embodiment has been described in detail as a specific example of the present disclosure above, the present disclosure is not limited by this specific description. Modifications, improvements and the like within a range in which the aim of the present disclosure can be achieved are included in the present disclosure. For example, the following modifications of the embodiment are also included in the technical scope of the present disclosure.
(1) Although the first and second fixing portions 58, 62 in the first and second contact pressure forming fittings 22a, 22b are fixed to the respective inner surfaces 20a, 20b of the upper and lower wall portions 32, 34 by welding and crimping in the above embodiment, there is no limitation to this mode. That is, each contact pressure forming fitting may be fixed to the inner surface only by either welding or crimping. Further, each contact point forming fitting may be fixed by a method other than welding and crimping or may be fixed to each inner surface, for example, by bolting. Further, even if each contact pressure forming fitting is welded, a conventionally known welding method such as arc welding or resistance welding can be adopted without limitation to laser welding as in the above embodiment.
(2) Although the first and second contact point forming fittings 22a, 22b have the same shape in the above embodiment, the shapes of these may be different from each other. For example, the number of first spring pieces provided in a first contact point forming fitting and that of second spring pieces in a second contact point forming fitting may be different from each other. Alternatively, materials of first and second contact point forming fittings may be different from each other.
(3) Although the first contact point forming fitting 22a is provided with the pair of first spring pieces 60, 60 and the second contact point forming fitting 22b is provided with the pair of second spring pieces 64, 64 in the above embodiment, the number of first spring pieces provided in a first contact point forming fitting and that of second spring pieces in a second contact point forming fitting are not limited. The first contact point forming fitting may be provided with one, three or more first spring pieces. Similarly, the second contact point forming fitting may be provided with one, three or more second spring pieces.
(4) Although the two sandwiching plate portions 86 are provided on each of the both upper and lower sides of the clip spring 82 to correspond to the numbers of the first spring pieces 60 and the second spring pieces 64 in the above embodiment, there is no limitation to this mode. That is, the numbers of sandwiching plate portions may be different on upper and lower sides in a clip spring. For example, one sandwiching plate portion may be provided on the upper side, and a plurality of sandwiching plate portions may be provided apart from each other in the lateral direction on the lower side. Note that the number of these sandwiching plate portions and that of the first and second spring pieces need not to correspond, the number of the sandwiching plate portions on the upper side and that of the first spring pieces may be different and that of the sandwiching plate portions on the lower side and the number of the second spring pieces may be different.
(5) Although the first and second contact point forming fittings 22a, 22b are provided on the respective inner surfaces 20a, 20b of the upper and lower wall portions 32, 34 facing each other in the vertical direction in the box-shaped conductive portion 16 in the above embodiment, first and second contact point forming fittings may be provided on inner surfaces of left and right wall portions facing each other in the lateral direction in a box-shaped conductive portion. In that case, the box-shaped conductive portion may have a vertically long shape with a vertical dimension larger than a lateral dimension and, at that time, a male terminal can have a vertically long shape with a vertical dimension larger than a lateral dimension.
(6) Although each first contact point 66 and each second contact point 68 are in contact with each other in the vertical direction in the state before the insertion of the male terminal 12 into the female terminal 10 (state shown in FIGS. 4 and 5) in the above embodiment, a first contact point and a second contact point may be slightly separated from each other in the vertical direction in the state before the insertion of a male terminal.
(7) The shapes of the first and second contact points are not limited. Besides having an oval shape with a front-rear dimension larger than a lateral dimension in a plan view as in the above embodiment, the first and second contact points may have, for example, a hemispherical shape or a shape with a lateral dimension larger than a front-rear dimension.
(8) Note that, in a female terminal according to the present disclosure, projecting end parts of first and second spring pieces only have to be biased in directions toward each other by a contact pressure applying spring and first and second contact points only have to be pressed into contact with a male terminal at least according to the insertion of the male terminal, and a mode before the insertion of the male terminal is not limited. That is, before the insertion of the male terminal, the first and second spring pieces may not be biased in the directions toward each other unlike in the above embodiment, or the projecting end parts of the respective first and second spring pieces may be biased in the directions toward each other by sandwiching plate portions of the contact pressure applying spring (clip spring).

### LIST OF REFERENCE NUMERALS

10 female terminal
12 male terminal
14 connecting portion
16 box-shaped conductive portion
18 body portion
20 facing inner surface
20a inner surface (of upper wall portion)
20b inner surface (of lower wall portion)
22 contact point forming fitting
22a first contact point forming fitting
22b second contact point forming fitting
24 bolt insertion hole
26 narrow portion
28 male terminal insertion opening
30 rear opening window
32 upper wall portion
34 lower wall portion
36 left wall portion
38 right wall portion
40 fitting protrusion
42 fitting recess
44 inner surface (of left wall portion)
46 inner surface (of right wall portion)
48 positioning protrusion
50 locking protrusion
52 vertical surface
54 engaging protrusion
56 bending portion
58 first fixing portion
60 first spring piece
62 second fixing portion
64 second spring piece
66 first contact point
68 second contact point
70 gap
72 bent portion
74 projecting end part
76 recess
78 welding portion
80 engaging hole
82 clip spring (contact pressure applying springs)
84 coupling plate portion
86 sandwiching plate portion
88 bent part
90 insertion opening
92 retainer
94 displacement restricting portion
96 fixing portion
98 locking hole

1. A female terminal, comprising:
a body portion including a connecting portion to be conductively connected to another member on one end side in a length direction and a hollow box-shaped conductive portion on the other end side in the length direction; and
a pair of contact point forming fittings having a smaller plate thickness than the body portion, the pair of contact point forming fittings being conductively fixed and held on a pair of facing inner surfaces of the box-shaped conductive portion,
the box-shaped conductive portion including a male terminal insertion opening open toward the other end side and a rear opening window open toward the one end side,
one of the pair of contact point forming fittings including a first fixing portion to be fixed to one of the pair of facing inner surfaces of the box-shaped conductive portion and a first spring piece cantilevered and held on the first fixing portion, the first spring piece projecting toward the rear opening window from the male terminal insertion opening,
the other of the pair of contact point forming fittings including a second fixing portion to be fixed to the other of the pair of facing inner surfaces of the box-shaped conductive portion and a second spring piece cantilevered and held on the second fixing portion, the second spring piece projecting toward the rear opening window from the male terminal insertion opening,
the first spring piece including a first contact point on a facing surface facing the second spring piece,
the second spring piece including a second contact point on a facing surface facing the first spring piece,
a contact pressure applying spring being arranged on projecting end parts of the respective first and second spring pieces, the contact pressure applying spring being sized to be insertable through the rear opening window, and the projecting end parts being biased in directions toward each other to press the first and second contact points into contact with the male terminal as the male terminal is press-fit between
the facing surfaces of the first and second spring pieces.

2. The female terminal of claim 1, wherein:
the contact pressure applying spring is constituted by a clip spring including a coupling plate portion in the form of a rectangular flat plate and a pair of sandwiching plate portions in the form of rectangular flat plates projecting in directions toward each other from both side edge parts of the coupling plate portion, and
the projecting end part of the first spring piece and the projecting end part of the second spring piece are sandwiched between the pair of sandwiching plate portions of the clip spring during insertion of the male terminal.

3. The female terminal of claim 1, wherein the first fixing portion of the one contact point forming fitting is fixed to the one facing inner surface of the box-shaped conductive portion by welding and the second fixing portion of the other contact point forming fitting is fixed to the other facing inner surface of the box-shaped conductive portion by welding.

4. The female terminal of claim 3, wherein the one contact point forming fitting is crimped and fixed to the one facing inner surface of the box-shaped conductive portion and the other contact point forming fitting is crimped and fixed to the other facing inner surface of the box-shaped conductive portion.

5. The female terminal of claim 1, wherein the box-shaped conductive portion includes a positioning protrusion projecting on an inner surface and an inward insertion end position of the contact pressure applying spring in the box-shaped conductive portion through the rear opening window is defined by contact of the contact pressure applying spring with the positioning protrusion.

6. The female terminal of claim 1, further comprising a retainer for covering the rear opening window by being assembled with the box-shaped conductive portion.

7. The female terminal of claim 6, wherein the retainer includes a displacement restricting portion for restricting a displacement of the contact pressure applying spring toward the rear opening window by being arranged in proximity to the contact pressure applying spring and contacting the contact pressure applying spring.

8. The female terminal of claim 1, wherein the body portion is a press-worked product constituted by a single metal flat plate and the connecting portion has the same plate thickness as the metal flat plate.

9. The female terminal of claim 2, wherein:
a plurality of the first spring pieces and a plurality of the second spring pieces respectively arranged at a plurality of positions separated from each other in a plate width direction of the male terminal are included,
the clip spring includes a plurality of pairs of the sandwiching plate portions respectively arranged at a plurality of positions separated from each other in the plate width direction, and
the projecting end parts of the plurality of first spring pieces and the projecting end parts of the plurality of second spring pieces are respectively separately sandwiched by the plurality of pairs of sandwiching plate portions during insertion of the male terminal.
